(19) United States
(12) Patent Application Publication
(10) Pub. No.: US 2007/0039653 A1
(43) Pub. Date: Feb. 22, 2007

(54) Switching valve

(76) Inventor: James J. Maggard, Osceola, MO (US)

Correspondence Address: HOVEY WILLIAMS LLP, 2405 GRAND BLVD., SUITE 400, KANSAS CITY, MO, 64108, US

(21) Appl. No.: 11/204,963

(22) Filed: Aug. 16, 2005

(51) Int. Cl. F16K 11/085

(52) U.S. Cl. 137/625.19

(57) ABSTRACT

A valve having one or more fluid conduits is operable to provide fluid flow configurations between various lines. The valve is operable to move between a first position, wherein a first fluid flow configuration is provided through the various lines, and a second position, wherein a second fluid flow configuration is provided through the various lines. The valve may include piston, plug, ball, and/or other valve configurations to provide an efficient, compact, and reliable valve operable to select fluid flow within a recirculation system.

### BACKGROUND OF THE INVENTION

1. Field of the Invention

The present invention relates to valves. More particularly, the invention relates to a switching valve operable to provide various fluid flow configurations through a plurality of lines.

2. Description of the Related Art

It is common to utilize one or more valves to control the flow of fluid through a pipeline. As various systems, such as recirculation systems, require primary and secondary lines, a plurality of separate valves are generally used to control flow through the primary and secondary lines. For example, in a recirculation system having two supply lines and two return lines, a valve is generally separately coupled with each line to control the flow of fluid therein, providing a total of four valves. Unfortunately, the utilization of a plurality of valves requires each valve to properly function and actuate in order to provide desired fluid flow. Thus, failure of any one of the plurality of valves, or their respective components, often results in improper system functionality and damage to equipment, such as damage caused by overheating.

Additionally, the utilization of a plurality of valves increases system switching time between primary and secondary lines. For example, to switch between a failed primary line, such as a line that has breached or overheated, and a secondary line to maintain proper system functionality, each valve must be independently actuated and controlled by external devices, thereby creating a switching delay due to the number of devices involved that may result in system failure and equipment damage. Thus, expensive and complex systems are often employed to ensure that a plurality of valves are controlled properly to provide adequate line switching. Unfortunately, such expensive and complex systems may also suffer failure themselves, thereby causing the valves, and the system as a whole, to fail.

### SUMMARY OF THE INVENTION

The present invention solves the above-described problems and provides a distinct advance in the art of valves. More particularly, the invention provides a switching valve operable to provide various fluid flow configurations through a plurality of lines. Such a configuration provides an efficient, compact, and reliable valve operable to select fluid flow between a plurality of lines within a recirculation system.

In one embodiment, the valve broadly includes a valve chamber, a plurality of supply, return, and output lines coupled with the valve chamber, a valve element positioned at least partially in the valve chamber and having at least one fluid conduit, and an actuation element coupled with the valve element to actuate the valve element between a first and second position. In the first position, the valve element provides a first fluid flow configuration through the lines and in the second position the valve element provides a second fluid flow configuration through the lines.

In another embodiment, the valve broadly includes a piston chamber; various supply, return, and output lines coupled with the piston chamber; a piston having narrow and wide portions positioned at least partially in the piston chamber; and an actuation element. The actuation element is operable to actuate the piston between a first position and a second position to enable various fluid flow configurations through the lines based on the position of the narrow and wide portions.

In another embodiment, the valve broadly includes a piston chamber; a primary supply line coupled with the piston chamber; a secondary supply line coupled with the piston chamber; an output supply line coupled with the piston chamber; a primary return line coupled with the piston chamber; a secondary return line coupled with the piston chamber; an output return line coupled with the piston chamber; a piston positioned at least partially in the piston chamber; and an actuation element to enable the piston to move between a first position and a second position.

The piston generally includes a first narrow portion and a second narrow portion each having a diameter substantially less than the internal diameter of the piston chamber and a first wide portion, a second wide portion, and a third wide portion each having a diameter substantially equal to the internal diameter of the piston chamber. In the first position, the first narrow portion enables fluid to flow from the primary supply line to the output supply line; the second narrow portion enables fluid to flow from the output return line to the primary return line; the second wide portion restricts fluid flow from the secondary supply line to the output supply line; and the third wide portion restricts fluid flow from the output return line to the secondary return line.

In the second position, the first narrow portion enables fluid to flow from the secondary supply line to the output supply line; the second narrow portion enables fluid to flow from the output return line to the secondary return line; the first wide portion restricts fluid flow from the primary supply line to the output supply line; and the second wide portion restricts fluid flow from the output return line to the primary return line.

In another embodiment, the invention includes a method of selecting a fluid flow configuration through a plurality of lines. The method generally comprises the steps of coupling a valve with various lines utilizing a valve chamber; positioning the valve in a first position at least partially in the valve chamber to provide a first fluid flow configuration through the lines; and positioning the valve in a second position at least partially in the valve chamber to provide a second fluid flow configuration through the lines.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a front view of a valve constructed in accordance with various preferred embodiments of the present invention, the valve having a piston shown in a first position;

FIG. 2 is a front view of the valve of FIG. 1, showing the piston in a second position;

FIG. 3 is a perspective view of the valve of FIGS. 1-2, showing the piston in a second position;

FIG. 4 is a front perspective view of the piston of FIGS. 1-3;

FIG. 5 is a front view of a piston chamber utilized by various embodiments of the present invention; and

FIG. 6 is a front view of a piston, biasing spring, and pressure adjustment screw utilized by various embodiments of the present invention.

FIG. 7 is a front perspective view of a valve constructed in accordance with various preferred embodiments of the present invention, the valve including a valve element having a three-way plug configuration;

FIG. 8 is a front sectional view of the valve of FIG. 7 showing the valve element in a first position providing a first fluid flow configuration;

FIG. 9 is a front sectional view of the valve of FIGS. 7-8 showing the valve element in a second position providing a second fluid flow configuration;

FIG. 10 is a front perspective view of a valve constructed in accordance with various preferred embodiments of the present invention, the valve including a valve element having a three-way ball configuration;

FIG. 11 is a front sectional view of the valve of FIG. 10 showing the valve element in a first position;

FIG. 12 is a top view of the valve of FIGS. 10-11 showing an upper portion of the valve element in the first position providing a first fluid flow configuration;

FIG. 13 is a top view of the valve of FIGS. 10-12 showing a lower portion of the valve element in the first position providing the first fluid flow configuration;

FIG. 14 is a front sectional view of the valve of FIGS. 10-13 showing the valve element in a second position;

FIG. 15 is a top view of the valve of FIGS. 10-14 showing an upper portion of the valve element in the second position providing a second fluid flow configuration;

FIG. 16 is a top view of the valve of FIGS. 10-15 showing a lower portion of the valve element in the second position providing the second fluid flow configuration;

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

Reference will now be made in detail to various preferred embodiments of the present invention, examples of which are illustrated in the accompanying drawings. Wherever possible, the same reference numbers are used throughout the drawings to refer to the same or like parts.

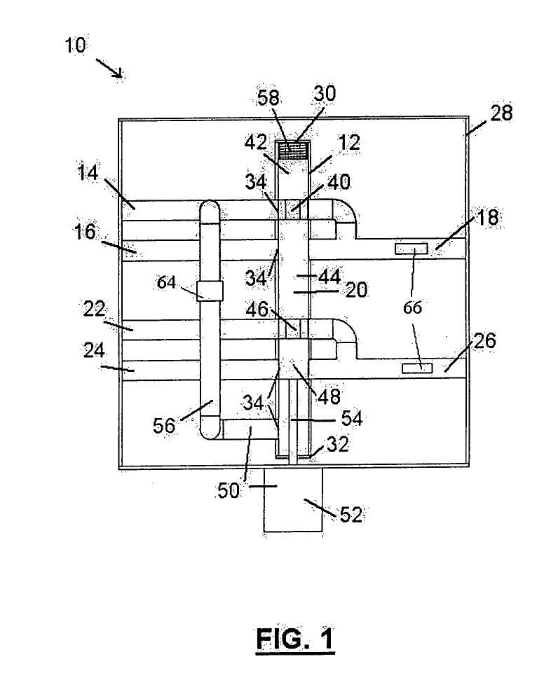

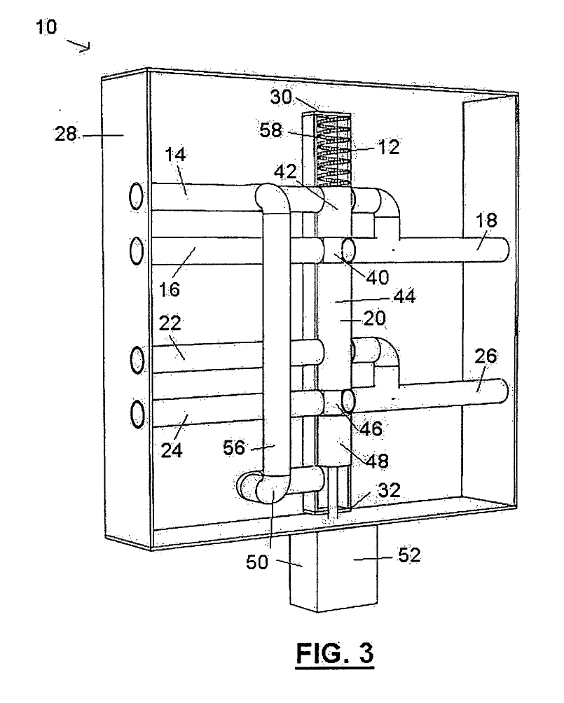

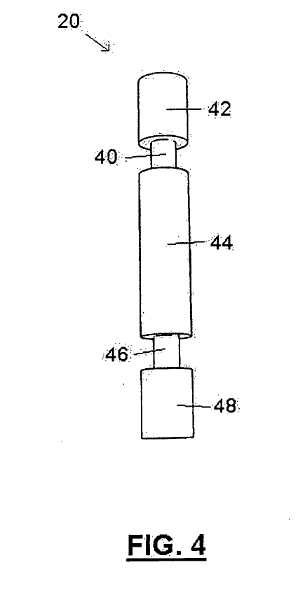

Referring to FIGS. 1-6, a valve 10 is shown constructed in accordance with various preferred embodiments of the present invention. As is described below in more detail, the valve 10 broadly includes a piston chamber 12; a primary supply line 14 coupled with the piston chamber 12; a secondary supply line 16 25 coupled with the piston chamber 12; an output supply line 18 coupled with the piston chamber 12; and a piston 20 positioned at least partially in the piston chamber 12 and operable to move between a first position and a second position to enable fluid to flow from at least one of the supply lines 14, 16 to the output supply line 18.

In various embodiments, the valve 10 may additionally include a primary return line 22 coupled with the piston chamber 12; a secondary return line 24 coupled with the piston chamber 12; and a output return line 26 coupled with the piston chamber. In such embodiments, the piston 20 is operable to move between the first position and the second position to enable fluid to flow from the output return line 26 to at least one of the return lines 22, 24.

The valve 10 preferably includes a housing 28 to house at least a portion of the piston chamber 12, piston 20, and lines 14, 16, 18, 22, 24, 26. The housing 28 enables the valve 10 to be compactly and securely configured for utilization in situations where limited installation space is available or where the inclusion of many separate valve housings is undesirable.

Preferably, the valve 10 includes both the supply lines 14, 16, 18 and return lines 22, 24, 26 as such a configuration may be desirable for recirculation applications, wherein the supply lines 14, 16 are utilized to carry cooling fluid to machinery and/or equipment and the return lines 14, 16 are utilized to return fluid from the machinery and/or equipment. However, the valve 10 may be utilized in any situation where it is desirable to select fluid flow from one or more fluid carrying lines.

The piston chamber 12 is operable to receive at least a portion of the piston 20. Preferably, the piston chamber 12 is generally cylindrical to reduce friction and wear between the piston chamber 12 and piston 20. Generally, the piston chamber 12 includes a distal end 30 and at least a partially open proximate end 32 to enable actuation of the enclosed piston 20. The proximate end 32 may include gaskets, seals, and other such elements to enable the reception of external actuation elements, desired below, without losing pressure or fluid from within the piston chamber 12. However, both ends 30, 32 may be generally closed or sealed such that the piston 20 may be entirely enclosed within the piston chamber 12.

Additionally, in some embodiments, the distal end 30, or other portions of the piston chamber 12, may be at least partially open to enable at least a portion of the piston 20 to abut from the piston chamber 12, and preferably the housing 28, to indicate the position of the piston 20. For example, in the first position, at least a portion of the piston 20 may extend through an opening in the distal end 30 to indicate position, while in the second position, the piston 20 may not extend through the distal end 30, or may not extend through the distal end 30 to same extent as in the first position, thereby indicating the position of the piston 20.

The piston chamber 12 also includes a plurality of apertures 34 to enable coupling of the lines 14, 16, 18, 22, 24, 26 and the piston chamber 12. Preferably, the apertures 34 are circular to enable fitting with the generally circular lines 14, 16, 18, 22, 24, 26 discussed below. However, the apertures 34 may be of any shape or configuration to enable sufficient coupling between the piston chamber 12 and lines 14, 16, 18, 22, 24, 26 to prevent undesirable fluid leakage between the lines 14, 16, 18, 22, 24, 26 and the chamber 12. For example, in some embodiments the lines 14, 16, 18, 22, 24, 26 and the piston chamber 12 may be sealingly coupled utilizing conventional sealing methods to prevent undesirable leakage or pressure loss within the piston chamber 12. Thus, the apertures 34 may include seals or gaskets to couple with the lines 14, 16, 18, 22, 24, 26 as shown in FIG. 6.

Apertures 34 corresponding to supply lines 14, 16 and return lines 22, 24 are preferably positioned on an opposite side of the piston chamber 12 than apertures 34 corresponding to output lines 18, 26, to facilitate fluid flow through the piston chamber 12. However, the apertures 34 may be positioned on any portion of the piston chamber 12 to facilitate a desired valve 10 configuration.

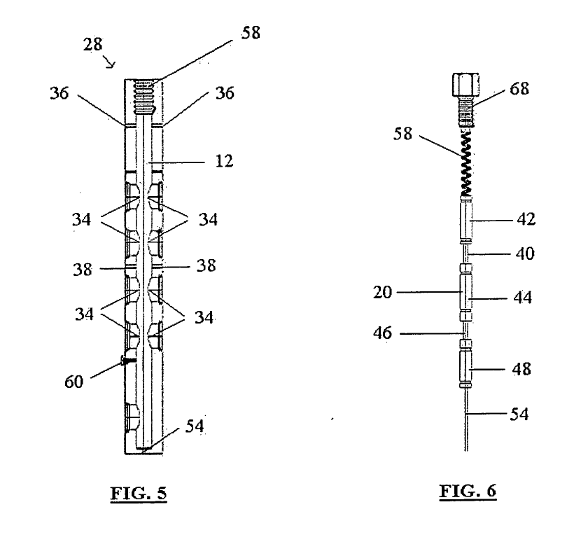

The piston chamber 12 may additionally include one or more weep holes 36 to prevent undesirable fluid buildup within the piston chamber 12 and/or one or more indicator holes 38 to indicate a fluid leak in portions of the piston chamber 12, such as in proximity to various seals that may couple the lines 14, 16, 18, 22, 24, 26 and piston chamber 12. As shown in FIG. 5, the weep holes 36 may be positioned above the supply lines 14, 16, 18 and the indicator holes 38 may be positioned in between the supply lines 14, 16, 18 and return lines 22, 24, 26 to prevent fluid buildup and detect leaks.

The supply lines 14, 16 are operable to carry fluid from a supply source and preferably include a circular cross-section. However, the supply lines 14, 16 may be any conduit operable to carry fluid from a source external from the valve 10. In various embodiments, the primary supply line 14 is operable to carry fluid from a primary fluid source for cooling external equipment while the secondary supply 16 is operable to carry fluid from a secondary fluid source for cooling equipment in situations where the cooling ability of the primary source is lost or diminished.

The output supply line 18 is preferably operable to carry fluid from the selected supply line 14, 16 to external equipment or devices requiring fluid. For example, the output supply line 18 may be operable to carry fluid for cooling the external equipment. However, the output supply line 18 may carry fluid to any devices or elements and need not be limited to cooling applications.

Preferably, the supply lines 14, 16 are arranged in a parallel configuration in proximity to the piston chamber 12 and the output supply line 18 is parallel or otherwise aligned with at least one of the supply lines 14, 16, to facilitate the flow of fluid from the supply lines 14, 16 to the output supply line 18. Additionally, the output supply line 18 may include a junction, such as a U junction, to facilitate the reception of flow from either of the supply lines 14, 16.

The return lines 22, 24, are generally similar to the supply lines 14, 16 and are similarly operable to carry fluid from an external source. Thus, the return lines 22, 24 may be operable to function as supply lines in a similar manner to supply lines 14, 16. Preferably, the return lines 22, 24 are configured to carry fluid from cooled external equipment, such that the output supply line 18 and primary return line 22 or secondary return line 24 may form a circulation loop. However, the lines 14, 16, 22, and 24 may be configured with external equipment or devices in any desired configuration.

The piston 20 is positioned at least partially in the piston chamber 12 and is operable to be positioned in the first position and second position within the piston chamber 12. The piston 20 includes at least one narrow portion and at least one wide portion to enable or restrict fluid flow through the various lines coupled with the piston chamber 12.

Preferably, the piston 20 is generally cylindrical and includes a first narrow portion 40 having a diameter substantially less than the internal diameter of the piston chamber and a first wide portion 42 and a second wide portion 44 each having a diameter substantially equal to the diameter of the piston chamber 12. The first narrow portion 40 may be positioned in between the first wide portion 42 and the second wide portion 44 to facilitate the desired functionality described below.

In embodiments including the return lines 22, 24, 26, the piston 20 additionally preferably includes a second narrow portion 46 having a diameter substantially less than the diameter of the piston chamber 12 and a third wide portion 48 having a diameter substantially equal to the diameter of the piston chamber 12. The second narrow portion 46 may be positioned between the second wide portion 44 and the third wide portion 48 to facilitate the desired functionality described below.

The diameters of the wide portions 42, 44, 48 enable the wide portions 42, 44, 48 to snugly fit within the piston chamber 12 to generally restrict fluid flow within and through the piston chamber 12, as is described below. For example, the wide portions 42, 44, 48 may abut and/or form a sealing relationship with internal walls of the piston chamber 12 to prevent fluid flow within the piston chamber 12. However, the diameters of the wide portions 42, 44, 48 need only be substantially equal to the internal diameter of the piston chamber 12 to enable the wide portions 42, 44, 48 to generally restrict fluid flow.

The narrow portions 40, 46 have diameters substantially less than the internal diameter of the piston chamber 12 to enable fluid flow through the piston chamber 12, as is described below. Although the narrow portions 40, 46 preferably have a generally circular cross-section, the narrow portions 40, 46 may include non-circular cross sections to facilitate the flow of fluid around the narrow portions 40, 46, such as oval, triangular, and other cross sectional areas. Furthermore, the narrow portions 40, 46 need not be centered about a longitudinal axis of the piston 20, as the narrow portions 40, 46 may comprise a hole, cavity, slot, groove, etc, or any other fluid conduit formed through or on the piston 20 to enable fluid flow.

The piston 20 may further include additional narrow and wide portions in embodiments where additional lines are coupled with the valve 10 for selection. In such embodiments, the narrow and wide portions are preferably arranged in an alternating totem pole configuration to function in a similar manner as the narrow and wide portions described herein.

As is described above, one or more portions of the piston 20 may be operable to extend from the piston chamber 12, and preferably housing 28, to indicate the position of the piston 20. For example, the first wide portion 42 may include an indicator ring, such as a colored region different in color from the rest of the piston 20, to indicate the position of the piston 20 when the first wide portion 42 is at least partially extended from the housing 28.

The valve 10 additionally includes an actuating element 50 to enable the piston 20 to move between the fist position and the second position. The actuating element 50 is coupled with the piston chamber 12 to directly or indirectly position the piston 20. For example, the actuating element 50 may include solenoids, pneumatics, hydraulics, a spring, and/or a motor 52, such as an electric motor, coupled with the piston chamber 12 and piston 20 through a drive shaft 54, to move the piston 20 between the first position and the second position.

Preferably, the actuating element 50 includes an auxiliary line 56 coupled between the primary supply line 14 and the piston chamber 12 to maintain the piston 20 in the first position utilizing fluid flow from the primary supply line 14. The auxiliary line 56 may be coupled with the piston chamber 12 below the piston 20, such as between the third wide portion 48 and the proximate end 32 of the piston chamber 12, such that fluid may flow from the primary supply line 14 to the piston chamber 12 to apply upward pressure to the piston 20 by filling the region between the piston 20 and the proximate end 32 of the piston chamber 12 with fluid.

In embodiments utilizing the auxiliary line 56, the actuating element 50 preferably additionally includes a bias spring 58 to bias the piston 20 towards the second position. The bias spring 58 may be positioned between the piston 20, such as the first wide portion 20, and the distal end 30 of the piston chamber 12 to apply a downward force, generally opposite the force provided by the auxiliary line 56, for biasing. However, the bias spring 58 may be positioned in different orientations to provide the desired biasing force.

Thus, should fluid flow through the primary supply line 14 substantially decrease such that the fluid pressure between the piston 20 and proximate end 32 of the piston chamber 12 is insufficient to overcome the force provided by the bias spring 58, gravity, or other actuating elements, the piston 20 may automatically move from the first position to the second position without requiring corroboration with control devices or sensors.

The actuating element 50 may additionally include a spring tensioned detent 60 to restrict movement of the piston 20 within the piston chamber 12. For example, the detent 60 may generally hold the piston 20 in a desired position, such as the first position, until a desired amount of force is applied to move the piston 20. The bias spring 58 and detent 60 may include pressure adjustment screws 68 to adust the degree of force provided by the bias spring 58 and detent 60 to a desired amount.

Furthermore, the actuating element 50 may include a non-automated manual actuator 64 to manually move the piston 20 between the first position and the second position. The manual actuator 64 may include piston locking elements or manual actuation of the motor 52 to enable the piston 20 to be manually positioned and generally held in place. In embodiments utilizing the auxiliary line 56, the manual actuator 64 preferably includes a valve coupled with the auxiliary line 56 to control fluid flow therein, to enable the piston 20 to be desirably positioned. Use of the manual actuator 64 may be desirable to enable movement of the piston 20 regardless of the existence or status of other actuating components, such as to enable the piston 20 to be positioned in a desired position for servicing while the valve 10 is in use.

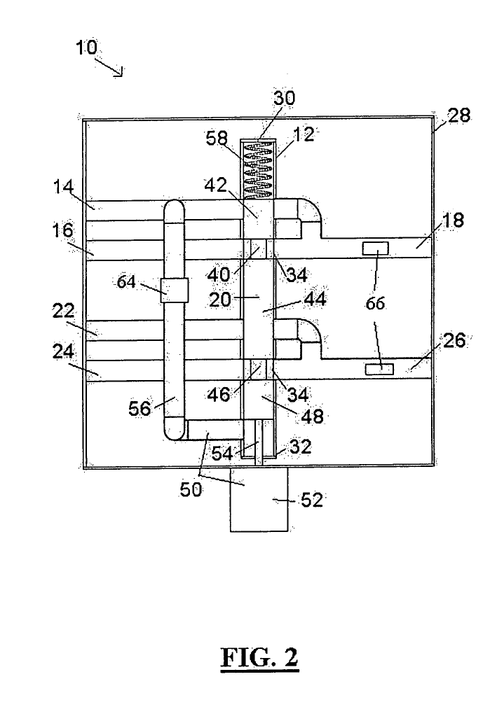

In various embodiments, the manual actuator 64 may include a three-way valve coupled with various supply lines, return lines, or the atmosphere such that actuation of the three-way valve reduces pressure within the auxiliary line 56 to enable the piston 20 to be forced into the second position due to the force provided by the bias spring 58. For example, as shown in FIGS. 1-2, the manual actuator 64 may be generally coupled with the proximate end 32 of the piston chamber 12 through the auxiliary line 56 and the atmosphere such that actuation of the manual actuator 64 reduces fluid pressure in the chamber 12 to cause the piston 20 to move to the second position. Further, the manual actuator 64 may be coupled with the proximate end 32 and one of the return lines 22,24 to achieve a similar result.

The actuating element 50 may include the motor 52, auxiliary line 56, and manual actuator 64 or the actuating element 50 may include any combination of these elements to achieve a desired result. Furthermore, the actuating element 50 may be electrically coupled, wired or wirelessly, with an external control system to enable the piston 20 to move between the positions in response to control signals provided by the control system.

The valve 10 may additionally include one or more sensors 66 to sense various valve 10 and fluid attributes. For example, the sensors 66 may sense fluid characteristics, such as temperature, volume, and pressure, within at least one of the supply or return lines, sense the position of the piston 20 within the piston chamber 12, sense temperature, volume, and pressure within the piston chamber 12, sense the status and amount of force provided by the actuating element 50, etc.

The sensors 66 are preferably electrically coupled, wired or wirelessly, with the external control system, or other elements of the valve 10 such as the actuating element 50, to enable the piston 20 to be actuated in response to sensed attributes, such as a decrease in pressure in the primary supply line 14, a change in fluid temperature, etc. Additionally, the sensors 66 may include computing elements to independently determine to move the piston 20 based upon sensed attributes such that coupling with the external control system is not required.

In operation, the valve 10 is operable to provide various fluid flow configurations. For instance, the valve 10 may be operable to provide various fluid flow configurations by positioning the piston 20 in the first position and in the second position. For example, in the first position, shown in FIG. 1, a first fluid flow configuration is provided by the first narrow portion 40 of the piston 20 being generally aligned within the piston chamber 12 with the primary supply line 14 such that fluid may flow through the primary supply line 14, around or through the first narrow portion 40, and into the output supply line 18 for cooling or other purposes.

Also in the first position, the second wide portion 44 is generally aligned with the secondary supply line 16 to restrict the flow of fluid from the secondary supply line 16 to the output supply line 18. Preferably, the second wide portion 44 generally prevents fluid flow from the secondary supply line 16 to the output supply line 16 by abutting, contacting, or sealing to the interior walls of the piston chamber 12 to physically prevent the flow of fluid.

In embodiments having the return lines 22, 24, 26, the second narrow portion 46 of the piston 20 is generally aligned with the primary return line 22 when the piston 20 is in the first position such that fluid may flow through the output return line 26, around or through the second narrow portion 46, and into the primary return line 22. Also in the first position, the third wide portion 48 is generally aligned with the secondary return line 24 to restrict the flow of fluid from the output return line 26 to the secondary return line 24. Preferably, the third wide portion 48 generally prevents fluid flow from the output return line 26 to the secondary return line 24 by abutting, contacting, or sealing to the interior walls of the piston chamber 12 to physically prevent the flow of fluid. Furthermore, at least a portion of the piston 20 may extend through the piston chamber 12 to indicate the position of the piston 20 in the first position.

The actuating element 50 may maintain the piston 20 in the first position through use of the auxiliary line 56, motor 52, detent 60, etc. For example, in embodiments having the auxiliary line 56, fluid may flow from the primary supply line 14, through the auxiliary line 56, and into the piston chamber 12 to provide pressure to maintain the piston 20 in the first position. Similarly, the motor 52, and/or detent 60, may provide force to maintain or position the piston 20 in the first position.

The sensors 66 may detect various attributes of the valve 10 and fluid flowing therefrom, as is described above, such as fluid pressure, temperature, etc. Based upon sensed attributes, the control system or the sensors 66 themselves may determine that the primary supply line 14 and/or primary return line 22 are no longer suitable for use and that the secondary supply line 16 and/or secondary return line 24 should be utilized instead. The sensors 66 and/or the control system may instruct the actuating element 50 to actuate and thereby move the piston 20 from the first position to the second position.

Additionally, the auxiliary line 56 may automatically switch between the primary lines 14, 22 and secondary lines 18, 24, without requiring instruction or input from the control system, sensors 66, or other elements. Specifically, upon a failure within the primary supply line 14 that causes a substantial decrease in fluid pressure therein, the fluid carried within the auxiliary line 56 will be inoperable to supply the needed force to maintain the piston 20 in the first position due to the effects of gravity and/or the bias spring 58. Thus, upon failure of the primary supply line 14, the auxiliary line 56 enables automatic switch-over to the secondary supply line 16 and secondary return line 24. Such a configuration may be desirable as it enables efficient, reliable, and independent redundancy without relying upon complex systems or instruments.

Furthermore, a user may manually move the piston 20 between the first position and the second position utilizing the manual actuator 64. Use of the manual actuator 64 may be desirable in situations where maintenance of the valve 10 or piston chamber 12 is required and it is needed to position the piston 20 in a position contrary to that indicated by the sensors 66 or provided by the actuating element 50. During maintenance, the user may lock the piston 20 in position utilizing the detent 60 or other similar locking devices.

In the second position, the valve 10 is operable to provide a second fluid flow configuration. For example, the first narrow portion 40 is generally aligned with the secondary supply line 16 such that fluid may flow through the secondary supply line 16, around or through the first narrow portion 40, and into the output supply line 18 for cooling or other purposes. Similarly, in embodiments having the return lines, the second narrow portion 46 is generally aligned with the secondary return line 24 to enable fluid to flow from the output return line 26, around or through the second narrow portion 46, and into the secondary return line 24.

Also in the second position, the first wide portion 42 is generally aligned with the primary supply line 14 to restrict the flow of fluid from the primary supply line 14 to the output supply line 18. Preferably, the first wide portion 42 generally prevents fluid flow from the primary supply line 14 to the output supply line 16 by abutting, contacting, or sealing to the interior walls of the piston chamber 12 to physically prevent the flow of fluid. Similarly, in embodiments having return lines, the second wide portion 44 is generally aligned with the primary return line 22 to restrict the flow of fluid from the output return line 26 to the primary return line 22.

The piston 20 may be maintained in the second position by the actuating element 50 until the sensors 66, the user, and/or the control system determines that it is more desirable to utilize flow through the primary lines 14, 22 instead of the secondary lines 16, 24. In embodiments utilizing the auxiliary line 56, the piston 20 may be automatically returned to the first position when sufficient flow is provided through the primary supply line 14 to provide pressure within the piston chamber 12 to return the piston 20 to the first position.

Preferably, the supply lines 14, 16 and return lines 20, 24 are arranged in a recirculation configuration to enable either the primary supply line 14 or the secondary supply line 16 to supply fluid to external machinery or equipment while enabling either the primary return line 22 or the secondary return line 24 to return fluid from the external machinery or equipment. Thus, in the first position fluid may flow through the primary supply line 14, the output supply line 18, the output return line 26, and the primary return line 22. However, the lines 14, 16, 20, 24 may be arranged in any configuration and need not be limited to recirculation configurations.

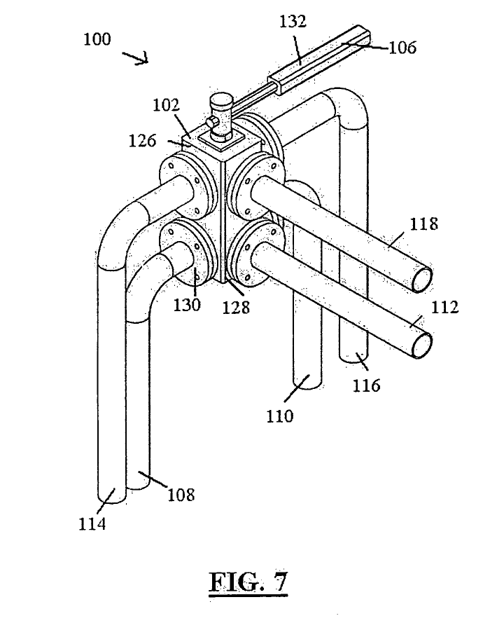

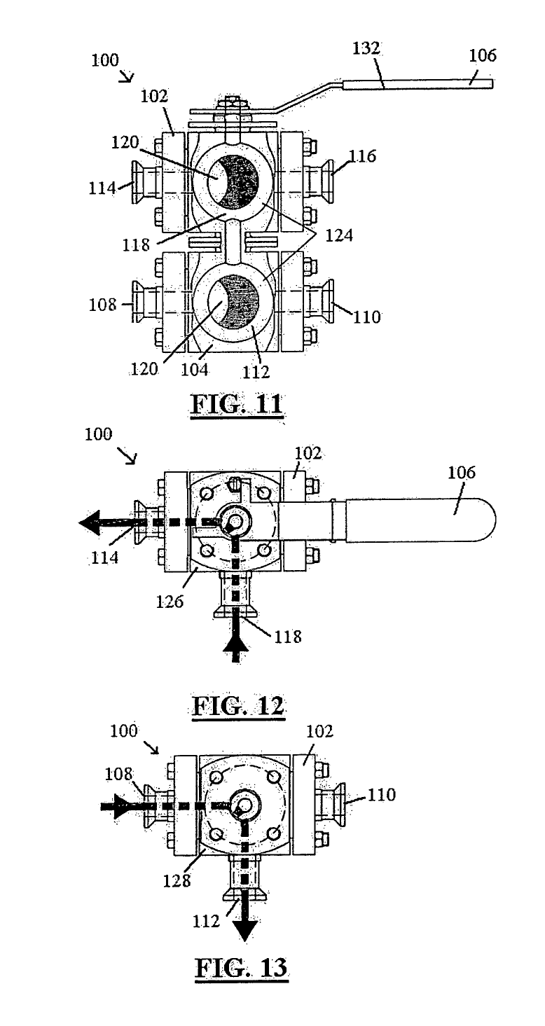

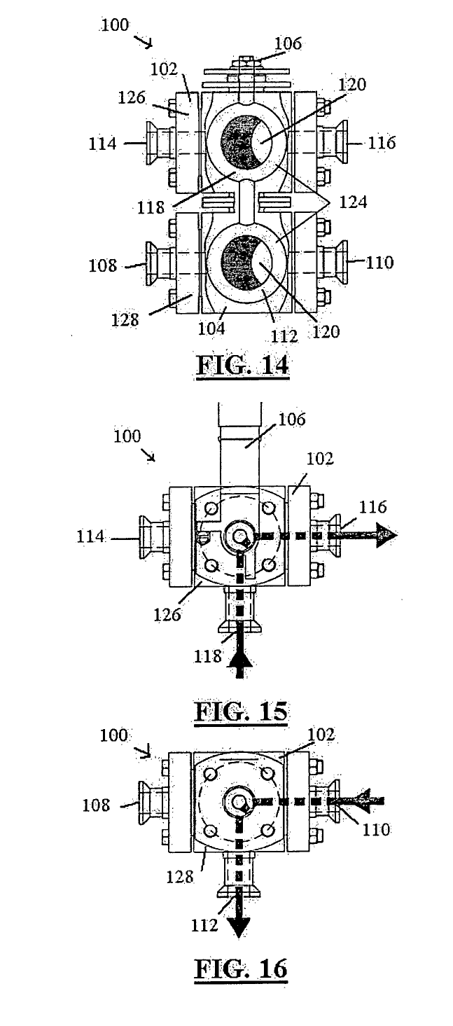

Referring to FIGS. 7-16, a valve 100 is shown constructed in accordance with various additional preferred embodiments of the present invention. The valve 100 generally similar to the valve 10 and includes a valve chamber 102, a valve element 104 positioned at least partially within the valve chamber 102, an actuation element 106 coupled with the valve element 104 or the valve chamber 102, and a plurality of lines coupled with the valve chamber 102. Preferably, a primary supply line 108, secondary supply line 110, output supply line 112, primary return line 114, secondary return line 116, and output return line 118, are each coupled with the valve chamber 102 in a similar manner to the line coupling of the valve 10. However, any combination or number of lines may be coupled with the valve 100 to achieve a desired result.

The valve element 104 includes at least one fluid conduit 120 to enable fluid to flow through the valve element 104. Positioning of the valve element 104 within the valve chamber 102 enables various fluid flow configurations to be provided as the position and alignment of the fluid conduits 120 in relation to the lines 108-118 determines the fluid flow path and configuration between the lines 108-118.

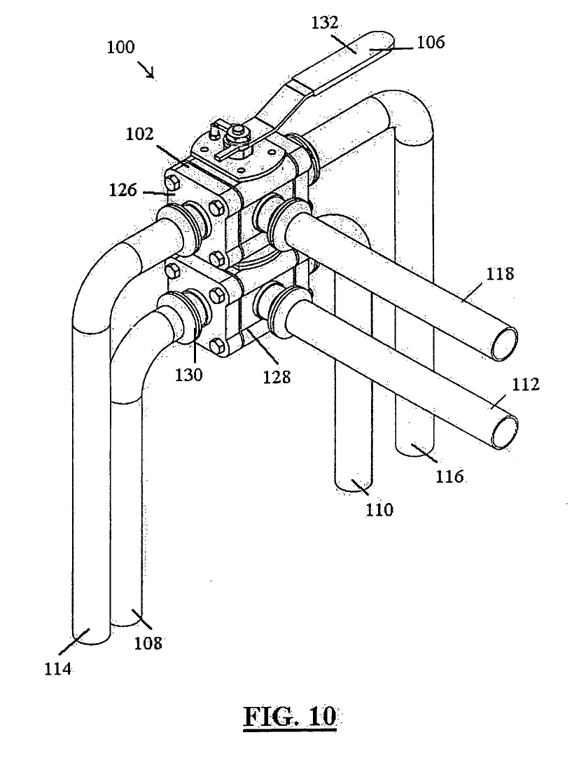

In various embodiments shown in FIGS. 7-9, the valve element 104 includes at least one plug 122 arranged in a three-way plug type valve configuration to enable fluid to flow through desired lines 108-118. In various embodiments shown in FIGS. 10-16, the valve element 104 includes at least one ball 124 arranged in a three-way ball type valve configuration to enable fluid to flow through the desired lines 108-118. Thus, the position of the plug 122 and/or ball 124 within the valve chamber 102 provides a fluid flow configuration relating to the position of the corresponding fluid conduits 120.

Preferably, the valve element 104 includes at least three sides for coupling with various lines and the fluid conduit 120 passes between only two of the sides such that fluid may flow between the two sides having the fluid conduit 120 but not the side or sides lacking the fluid conduit 120 based on the position of the valve element 104 within the valve chamber 102.

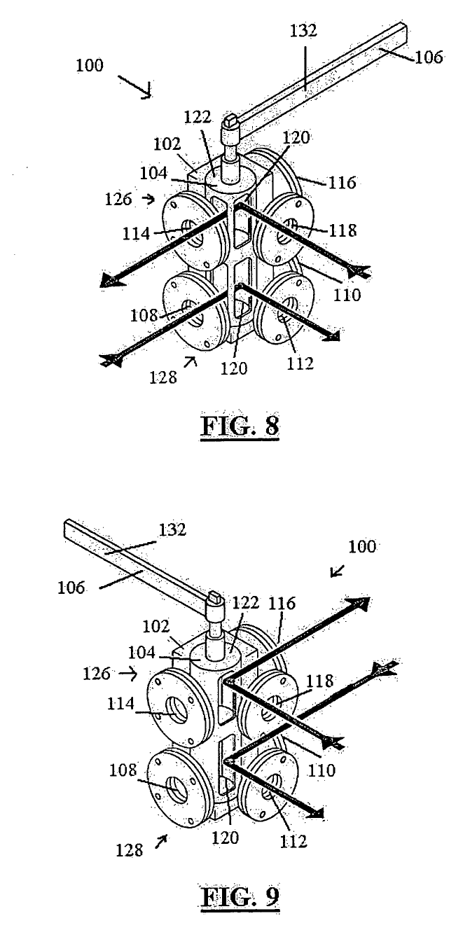

The valve element 104 also preferably includes an upper portion 126 and a lower portion 128. As shown in FIGS. 8-9, 11, and 14, the upper portion 126 and lower portion 128 may each include a separate fluid conduit 120 to enable the valve 100 to be utilized in recirculation configurations such that return fluid may flow through the upper portion 126 and supply fluid may flow through the lower portion 128 or in an opposite configuration if desired.

The upper portion 126 and lower portion 128 may be discrete elements coupled together and housed within the valve chamber 102, as shown in the ball-type embodiments of FIGS. 10-16, or the upper portion 126 and lower portion 128 may be integral elements housed within the valve chamber 102, as shown in the plug-type embodiments of FIGS. 7-9. In embodiments where the upper and lower portions 126, 128 are not integral they may be coupled by a coupling element such that movement of the upper portion 126 imparts similar movement to the lower portion 128. Further, the upper portion 126 and lower portion 128 may each include piston, plug, ball, and conventional valve elements configured together to form the valve element 104.

Preferably, the upper portion 126 and lower portion 128 are aligned such that the respective fluid conduits 120 enable selection of primary lines 108, 114 or secondary lines 110, 116. For example, the primary lines 108, 114 may be received by the portions 126, 128 on a first side, the secondary lines 110, 116 may be received by the portions 126, 128 on a second side, and the output lines 112, 118 may be received by the portions 126, 128 on a third side such that the portions 126, 128 may function in a generally similar and simultaneous manner to select between the primary lines 108, 114 and secondary lines 110, 116.

The various lines 108-118 are coupled with the valve chamber 102 to enable various fluid flow configurations to be provided based upon the position of the fluid conduits 120, as is described in more detail below. Preferably, the return lines 114-118 are associated with the upper portion 126 and the supply lines 108-112 are associated with the lower portion 128 such that various supply and return lines may be selected by the valve 100. The various lines 108-118 may be coupled with the valve chamber 102 through various methods, including conventional gaskets 130, seals, and other elements discussed above concerning the valve 10. As will be readily appreciated by those skilled in the art, the lines 108-118 may be coupled with any portion of the valve 100 and need not be limited to the specific coupling arrangement discussed herein.

The actuation element 106 is coupled with the valve chamber 102 or valve element 104 to enable the valve element 104 to be actuated between various positions within the valve chamber 102. As shown in FIGS. 7-16, the actuation element 106 may include a lever 132 coupled with the valve element 104 to enable a user to position the valve element 104 within the valve chamber 102.

In embodiments including the upper and lower portions 126, 128, the actuation element 106 may be coupled with the upper portion 126 to provide desired movement to the valve element 104 due to integral or non-integral coupling of the upper and lower portions 126, 128.

The actuation element 106 may comprise other or additional elements, such as motors, solenoids, or other automated devices operable to position the valve element 104 without requiring manual exertion by a user. The valve 100 may additionally include elements similar to those disclosed above regarding the valve 10, such as sensors, indicators, weep holes, bias springs, detents, control systems, pressure screws, etc, to provide desired functionality.

In operation, the valve 100 is operable to provide various fluid flow configurations. For instance, the valve 100 may be operable to provide various fluid flow configurations utilizing the fluid conduits 120 by positioning the valve element 104 in a first position and in a second position utilizing the actuation element 106.

In the first position, the fluid conduits 120 are positioned to provide a first fluid flow configuration. For example, a user may utilize the actuation element 106, such as by turning the lever 132, to position the valve element 104 in the first position. Preferably, the valve element 104 is positioned by aligning the fluid conduits 120 in the first position with the primary lines 108, 114 and output lines 112, 118 such that flow may flow from the primary supply line 108 to the supply output line 112 and from the output return line 118 to the primary return line 114, as shown in FIGS. 8 and 11-13. Similarly, the valve element 104 restricts the flow of fluid, such as by blocking fluid flow, between the secondary lines 110, 116 and the output lines 112, 118 such that the primary lines 108, 114 are preferably exclusively utilized.

In situations where use of the primary lines 108, 114 is no longer desirable, due to fluid breach, overheating, system failure, or other undesirable events, the user may utilize the actuation element 106, such by be turning the lever 132, to enable the valve 100 to provide a second fluid flow configuration. Similarly, the valve 100 may automatically actuate to the second position utilizing sensors, motors, or other automated elements.

In the second position, the valve element 104 is preferably positioned by aligning the fluid conduits 120 with the secondary lines 110, 116 and the output lines 112, 118 such that fluid may flow from the secondary supply line 110 to the output supply line 112 and from the output return line 118 to the secondary return line 116, as shown in FIGS. 9 and 14-16. Similarly, the valve element 104 restricts the flow of fluid, such as by blocking fluid flow, between the primary lines 108, 114 and the output lines 112, 118 such that the secondary lines 110, 116 are preferably exclusively utilized. The valve element 104 may be maintained in the second position until it is more desirable to utilize flow through the primary lines 108, 114 instead of the secondary lines 110, 116, in which cause the actuation element 106 may be utilized to return the valve element 104 to the first position.

The various embodiments of the valves 10, 100 disclosed herein may be particularly useful in mission critical recirculation systems, such as those utilized in the medical, semiconductor, pharmaceutical, automotive, and aerospace industries, where efficient and reliable switching between primary and secondary lines is desirable. However, the valves 10, 100 may be used in any environment where selection between fluid-carrying lines is required, such as temperature control loops, hydraulic power loops, recirculated chemical supply systems, backup fluid systems, etc.

Furthermore, the valves 10, 100 may coupled with other similarly, or identically, configured valves to enable selection between any number of fluid-carrying lines. Such a gang-configuration may be desirable in situations where multiple redundant recirculation systems are utilized or in situations where it is desirable to undertake selection of a plurality of fluid-carrying lines at discrete and separate locations.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A valve comprising:
a valve chamber;
a plurality of supply lines coupled with the valve chamber;
an output supply line coupled with the valve chamber;
a plurality of return lines coupled with the valve chamber;
an output return line coupled with the valve chamber;
a valve element positioned at least partially in the valve chamber, the valve element including a first fluid conduit associated with the return lines and a second fluid conduit associated with the supply lines; and
an actuation element coupled with the valve element to enable the valve element to move from a first position to a second position,
wherein in the first position, the valve element provides a first fluid flow configuration through the lines, and
wherein the second position, the valve element provides a second fluid flow configuration through the lines.

2. The valve of claim 1, wherein the valve element comprises a piston having wide and narrow portions.

3. The valve of claim 1, wherein the valve element includes a three-way plug type valve.

4. The valve of claim 1, wherein the valve element includes a three-way ball type valve.

5. A valve comprising:
a piston chamber;
a plurality of supply lines coupled with the piston chamber;
an output supply line coupled with the piston chamber;
a plurality of return lines coupled with the piston chamber;
an output return line coupled with the piston chamber;
a piston positioned at least partially in the piston chamber, the piston including—
at least one narrow portion having a diameter substantially less than the internal diameter of the piston chamber, and
at least one wide portion having a diameter substantially equal to the internal diameter of the piston chamber; and
an actuation element coupled with the piston chamber to enable the piston to move from a first position to a second position,
wherein in the first position, the narrow and wide portions provide a first fluid flow configuration through the lines, and
wherein the second position, the narrow and wide portions provide a second fluid flow configuration through the lines.

6. The valve of claim 5, wherein the actuation element includes an auxiliary line coupled between a primary supply line and the piston chamber to maintain the piston in the first position utilizing fluid pressure from the primary supply line.

7. The valve of claim 6, wherein a substantial decrease in fluid pressure in the primary supply line causes the piston to move from the first position to the second position.

8. The valve of claim 6, wherein the actuation element further includes a spring to bias the piston towards the second position.

9. The valve of claim 5, wherein the actuation element includes a motor to actuate the piston.

10. The valve of claim 5, wherein the piston includes a first narrow portion and a second narrow portion each having a diameter substantially less than the internal diameter of the piston chamber.

11. The valve of claim 5, wherein the piston includes a first wide portion, a second wide portion, and a third wide portion each having a diameter substantially equal to the internal diameter of the piston chamber.

12. A valve comprising:
a piston chamber;
a piston positioned at least partially in the piston chamber, the piston including—
a first narrow portion and a second narrow portion each having a diameter substantially less than the internal diameter of the piston chamber, and
a first wide portion, a second wide portion, and a third wide portion each having a diameter substantially equal to the internal diameter of the piston chamber;
a primary supply line coupled with the piston chamber;
a secondary supply line coupled with the piston chamber;
an output supply line coupled with the piston chamber;
a primary return line coupled with the piston chamber;
a secondary return line coupled with the piston chamber;
an output return line coupled with the piston chamber; and
an actuation element coupled with the piston chamber to enable the piston to move from a first position to a second position,
wherein in the first position—
the first narrow portion enables fluid to flow from the primary supply line to the output supply line,
the second narrow portion enables fluid to flow from the output return line to the primary return line,
the second wide portion restricts fluid flow from the secondary supply line to the output supply line, and
the third wide portion restricts fluid flow from the output return line to the secondary return line, and
wherein in the second position—
the first narrow portion enables fluid to flow from the secondary supply line to the output supply line,
the second narrow portion enables fluid to flow from the output return line to the secondary return line,
the first wide portion restricts fluid flow from the primary supply line to the output supply line, and
the second wide portion restricts fluid flow from the output return line to the primary return line.

13. The valve of claim 12, wherein the actuation element includes an auxiliary line coupled between the primary supply line and the piston chamber to maintain the piston in the first position utilizing fluid pressure from the primary supply line.

14. The valve of claim 13, wherein a substantial decrease in fluid pressure in the primary supply line causes the piston to move from the first position to the second position.

15. The valve of claim 12, wherein the actuation element includes a motor to actuate the piston.

16. A method of providing a fluid flow configuration through a plurality of lines, the method comprising the steps of:
coupling a valve with a primary supply line, a secondary supply line, an output supply line, a primary return line, a secondary return line, and an output return line utilizing a valve chamber;
positioning the valve in a first position at least partially in the valve chamber to provide a first fluid flow configuration through the lines; and
positioning the valve in a second position at least partially in the valve chamber to provide a second fluid flow configuration through the lines.

17. The method of claim 16, wherein the valve includes a first fluid conduit associated with the return lines and a second fluid conduit associated with the supply lines.

18. The method of claim 16, wherein the valve includes a three-way plug type valve element.

19. The method of claim 16, wherein the valve includes a three-way ball type valve element.

20. The method of claim 16, wherein the valve includes a piston comprising narrow and wide piston portions.
